(19) United States
(12) Patent Application Publication
(10) Pub. No.: US 2021/0080124 A1
(43) Pub. Date: Mar. 18, 2021

(54) MULTI-FUNCTIONAL CONVECTION ELECTRIC HEATER

(71) Applicant: NINGBO SHUNCHAO BEARINGS CO., LTD., Zhejiang (CN)

(72) Inventor: Gaoli Ge, Zhejiang (CN)

(21) Appl. No.: 16/962,485

(22) PCT Filed: Apr. 12, 2019
(86) PCT No.: PCT/CN2019/082530

§ 371 Date: Jul. 15, 2020

(30) Foreign Application Priority Data
Jun. 7, 2018 (CN) 201810577961.7

(51) Int. Cl. F24D 19/10; F24D 5/00; F24D 7/00; F24D 19/00; G06K 9/40; G06T 5/40; G06T 7/11; G06K 9/46; G06K 9/62; G06K 9/00; H04N 5/225; G06K 9/20; G06T 7/136; H04N 7/18; B08B 7/02

(52) U.S. Cl. CPC F24D 19/1096; F24F 2110/64; F24D 7/00; F24D 19/008; G06K 9/40; G06T 5/40; G06T 7/11; G06K 9/4604; G06K 9/6201; G06K 9/00771; H04N 5/2256; G06K 9/2054; G06T 7/136; H04N 7/183; B08B 7/028; F24D 2220/042; F24D 5/00

(57) ABSTRACT

The present invention relates to a multi-functional convection electric heater, comprising: a heating structure, which comprises a ceramic tubular device and a convection device, used to supply a heating source, and the convection device is connected with the ceramic tubular device, and is used to receive the heat supplied from the ceramic tubular device, and performs subsequent heating in a convection manner; a CMOS sensing device, which is used to capture a surrounding environment to obtain and output a corresponding surrounding environment image; and a homomorphic filtering device, which is connected with the CMOS sensing device, and is used to receive the surrounding environment image, and performs homomorphic filtering to obtain a corresponding homomorphic filtering image, wherein as the noise amplitude of the surrounding environment image gets larger, the intensity of performing the homomorphic filtering will be increased. The present invention enriches the electronic functions of the convection electric heater.

### TECHNICAL FIELD

The present invention relates to the field of convection electric heaters, in particular to a multi-functional convection electric heater.

### BACKGROUND ART

Electric heaters are filled with a novel type of heat-conductive oil. After the power is turned on, the heat-conductive oil around the electric heating coil is heated, and heat is dissipated out along the heating coil or the flakes. When the oil temperature reaches 85 ° C., the power supply of temperature control element is automatically turned off. The heat-conductive oil of electric heaters does not need to be replaced. It has a long service life. The electric heater is suitable for use in living rooms, bedrooms, aisles and households with elderly and children, and has the advantages of being safe, sanitary, dust-free and tasteless. The number of radiating fins in oil heaters are either 7 pieces, 9 pieces, 10 pieces, 12 pieces and the like, and the power can be adjusted by selecting the number of radiating fins. The power consumption is about 1500 watts.

### SUMMARY OF THE INVENTION

In order to solve the technical problem of insufficient auxiliary functions of current electric heaters, the present invention provides a multi-functional convection electric heater. By analyzing the gray value of images, different content processing strategies are determined, thereby improving the feature enhancement effect of images. The scope of image recognition is further narrowed through homomorphic filter processing, histogram equalization processing and threshold adjustment of each sub-image of image segmentation, and the amount of data for subsequent image processing is reduced. The ultrasonic dust removal method with an intensity proportional to the number of dust regions in the image is adopted to improve the intelligent level of dust removal. The key is the synergistic application of multiple dust detection methods which ensures the accuracy of dust detection. Based on the above data processing, it is possible to judge the clothing of nearby human subjects to determine whether to activate the key monitoring mode, thereby improving the security and prevention capabilities of nearby areas.

According to an aspect of the present invention, a multi-functional convection electric heater is provided. The electric heater comprising:
a heating structure, which comprises a ceramic tubular device and a convection device, wherein the ceramic tubular device is used to supply a heating source, and the convection device is connected with the ceramic tubular device, and is used to receive the heat supplied from the ceramic tubular device, and performs subsequent heating in a convection manner, and a CMOS sensing device, which is used to capture a surrounding environment to obtain and output a corresponding surrounding environment image.

More specifically, the multi-functional convection electric heater further comprising:
a homomorphic filtering device, which is connected with the CMOS sensing device, and is used to receive the surrounding environment image, performs homomorphic filtering on the surrounding environment image to obtain a corresponding homomorphic filtering image, wherein as the noise amplitude of the surrounding environment image gets larger, the intensity of performing the homomorphic filtering will be increased, and an equalization processing device, which is connected with the homomorphic filtering device, and is used to receive the homomorphic filtering image, and performs histogram equalization processing on the homomorphic filtering image to obtain a corresponding histogram equalization image.

More specifically, the multi-functional convection electric heater further comprising:
a first threshold extraction device, which is connected with the equalization processing device, and is used to receive the histogram equalization image, and determines an overall segmentation threshold corresponding to the histogram equalization image based on a distribution condition of pixel values of each pixel point in the histogram equalization image; a first parameter analysis device, which is used to receive the histogram equalization image, and performs contrast analysis on the histogram equalization image to obtain and output a corresponding contrast; a first segmentation processing device, which is connected with the first parameter analysis device, and is used to receive the contrast, and performs image segmentation processing on the histogram equalization image based on the contrast to obtain a plurality of sub-images, wherein the higher the contrast is, the more the number of sub-images will be obtained; a second threshold extraction device, which is connected with the first segmentation processing device, and is used to receive the plurality of sub-images, determines a region segmentation threshold corresponding to the sub-image based on a distribution condition of pixel values of each pixel point in each sub-image, and to output each region segmentation threshold corresponding to each sub-image; a first numerical adjustment device, which is respectively connected with the second threshold extraction device and the first threshold extraction device, and is used to receive the overall segmentation threshold and each region segmentation threshold, performs numerical adjustment on each region segmentation threshold based on the overall segmentation threshold to obtain an adjusted region segmentation threshold as a region adjustment threshold output; and performs numerical adjustment on each region segmentation threshold based on the overall segmentation threshold in the first numerical adjustment device, which comprises: performs numerical adjustment on the region segmentation threshold based on a difference size of the overall segmentation threshold to each region segmentation threshold; and performs numerical adjustment on the region segmentation threshold based on a difference size of the overall segmentation threshold to each region segmentation threshold in the first numerical adjustment device, which comprises: the adjusted region segmentation threshold is the sum of the region segmentation threshold and a quarter of the difference; a second segmentation processing device, which is connected with the first numerical adjustment device, and is used to perform segmentation processing on the region adjustment threshold corresponding to each sub-image to obtain a corresponding target sub-image, and to combine all the target sub-images to obtain and output the combined image; a content analysis device, which is connected with the second segmentation processing device, and is used to receive the combined image, acquires a gray value of each pixel point in the combined image, and performs the following operations for each pixel point: determines whether the pixel point is an edge point based on the gray value of the pixel point and the gray values of pixel points around the pixel point; wherein, to determine whether the pixel point is an edge point based on the gray value of the pixel point and the gray values of pixel points around the pixel point in the edge point extraction device, which comprises: calculates the mean value of the gray values of the pixel points around the pixel point, determines the difference between the mean value and the gray value of the pixel point, and determines that the pixel point is an edge point when the absolute value of the difference exceeds a limit, and determines that the pixel point is a background point when the absolute value of the difference does not exceed a limit; the content analysis device is further used to determine the number of edge points in the combined image, and determines the number of pixel points in the combined image; when the ratio of the number of edge points in the combined image to the number of pixel points in the combined image is lower than a limit, a first operation signal is emitted, and when the ratio of the number of edge points in the combined image to the number of pixel points in the combined image exceeds a limit, a second operation signal is emitted; a content processing device, which is connected with the content analysis device, and is used to perform feature enhancement processing on the combined image when the first operation signal is received, thereby to obtain a corresponding content processing image, wherein the content processing device performs feature enhancement processing on the combined image with an intensity proportional to the number of edge points in the combined image; a clothing identification device, which is connected with the content processing device, and is used to receive the content processing image, matching the clothing of the character object in the content processing image based on the clothing of various preset suspicious characters, outputting a key monitoring signal if the matching is successful, and outputting a non-key monitoring signal if the matching fails; and a ZIGBEE communication device, which is connected with the clothing identification device, and is used to pack the key monitoring signal and the serial number of the heating mechanism together and send to a nearby safety monitoring control center when the key monitoring signal is received.

More specifically, the multi-functional convection electric heater further comprising:
a light source device, which is disposed directly above the CMOS sensing device, and is used to send a beam of parallel monochromatic light to the surface of the CMOS sensing device, wherein the light source device emits a parallel monochromatic light with constant light emitting power.

More specifically, the multi-functional convection electric heater further comprising:
a light source control device, which is disposed directly above the CMOS sensing device and connected with the light source device, and is used to control the turning on and off of the parallel light emitter.

More specifically, the multi-functional convection electric heater further comprising:
a signal measuring device, which is disposed on the surface of the CMOS sensing device, and is used to measure the voltage obtained by converting the parallel monochromatic light into an electrical signal which is used as an actual voltage, divides the actual voltage by a preset reference voltage to obtain a relative attenuation rate, sends a first prompt information when the relative attenuation rate exceeds a limit, and sends a second prompt information when the relative attenuation rate does not exceed a limit, wherein the preset reference voltage is a voltage obtained by converting the parallel monochromatic light into an electric signal when there is no gray scale on the CMOS sensing device.

More specifically, the multi-functional convection electric heater further comprising:
a signal analysis device, which is connected with the signal measuring device and the CMOS sensing device, and is used to enter a working mode from a power saving mode when the first prompt information is received, and performs the following operations on the surrounding environment image in the working mode: taking the pixel point of a brightness value in a preset dust brightness value range as a pixel point to be processed, and fits each to-be-processed pixel point in the surrounding environment image into a plurality of regions to be processed; wherein the signal analysis device is also used to receive the plurality of regions to be processed, taking the regions to be processed which have an area matching with the preset dust area as a dust region, and sends a third prompt information when the number of dust regions in the surrounding environment image exceeds a limit.

More specifically, the multi-functional convection electric heater further comprising:
an intelligent processing device, which is connected with the signal analysis device, and is used to receive the number of dust regions in the surrounding environment image from the signal analysis device when the third prompt information is received, and adopts an ultrasonic dust removal mode which has an intensity directly proportional to the number based on the number of dust regions in the surrounding environment image.

More specifically, in the multi-functional convection electric heater, the intelligent processing device is further used to connect with the signal measuring device, and is used to stop the ultrasonic dust removal mode when the second prompt information is received.

### DETAIL METHOD OF IMPLEMENTATION

The following is a detail description on embodiments of the multi-functional convection heater of the present invention.

Electric heaters generally adopt the fully transparent high-temperature electric heating film as heating material, which is an advanced technology in the world. A hot air ducting structure is adopted, and the heat transfer method is enhanced convection. The thermal starting speed is fast, and the air outlet temperature can reach more than 100° C. within 3 minutes, but cools down quickly after power off. As the electric heating film is non-oxidized automatically when heated, the service life can be 100,000 hours, and it has the characteristics of small size and attractive appearance.

To overcome the above deficiencies, the present invention builds a multi-functional convection heater, which can effectively solve the corresponding technical problems.

The multi-functional convection heater according to the embodiment of the present invention comprising:
a heating structure, which comprises a ceramic tubular device and a convection device, wherein the ceramic tubular device is used to supply a heating source, and the convection device is connected with the ceramic tubular device, and is used to receive the heat supplied from the ceramic tubular device, and performs subsequent heating in a convection manner; and
a CMOS sensing device, which is used to capture a surrounding environment to obtain and output a corresponding surrounding environment image;

Next, the specific structure of the multi-functional convection heater of the present invention will be further elaborated.

The multi-functional convection heater further comprising:
a homomorphic filtering device, which is connected with the CMOS sensing device, and is used to receive the surrounding environment image, performs homomorphic filtering on the surrounding environment image to obtain a corresponding homomorphic filtering image, wherein as the noise amplitude of the surrounding environment image gets larger, the intensity of performing the homomorphic filtering will be increased; and
an equalization processing device, which is connected with the homomorphic filtering device, and is used to receive the homomorphic filtering image, performs histogram equalization processing on the homomorphic filtering image to obtain a corresponding histogram equalization image.

The multi-functional convection heater further comprising:
a first threshold extraction device, which is connected with the equalization processing device, and is used to receive the histogram equalization image, and determines an overall segmentation threshold corresponding to the histogram equalization image based on a distribution condition of pixel values of each pixel point in the histogram equalization image;
a first parameter analysis device, which is used to receive the histogram equalization image, and performs contrast analysis on the histogram equalization image to obtain and output a corresponding contrast;
a first segmentation processing device, which is connected with the first parameter analysis device, and is used to receive the contrast, and performs image segmentation processing on the histogram equalization image based on the contrast to obtain a plurality of sub-images, wherein the higher the contrast is, the more the number of sub-images will be obtained;
a second threshold extraction device, which is connected with the first segmentation processing device, and is used to receive the plurality of sub-images, determines a region segmentation threshold corresponding to the sub-image based on a distribution condition of pixel values of each pixel point in each sub-image, and to output each region segmentation threshold corresponding to each sub-image;
a first numerical adjustment device, which is respectively connected with the second threshold extraction device and the first threshold extraction device, and is used to receive the overall segmentation threshold and each region segmentation threshold, and performs numerical adjustment on each region segmentation threshold based on the overall segmentation threshold to obtain an adjusted region segmentation threshold as a region adjustment threshold output; and performs numerical adjustment on each region segmentation threshold based on the overall segmentation threshold in the first numerical adjustment device, which comprises: performs numerical adjustment on the region segmentation threshold based on a difference size of the overall segmentation threshold to each region segmentation threshold; performs numerical adjustment on the region segmentation threshold based on a difference size of the overall segmentation threshold to each region segmentation threshold in the first numerical adjustment device, which comprises: the adjusted region segmentation threshold is the sum of the region segmentation threshold and a quarter of the difference;
a second segmentation processing device, which is connected with the first numerical adjustment device, and is used to perform segmentation processing on the region adjustment threshold corresponding to each sub-image to obtain a corresponding target sub-image, and to combine all the target sub-images to obtain and output the combined image;
a content analysis device, which is connected with the second segmentation processing device, and is used to receive the combined image, acquires a gray value of each pixel point in the combined image, and performs the following operations for each pixel point: determines whether the pixel point is an edge point based on the gray value of the pixel point and the gray values of pixel points around the pixel point; wherein, to determine whether the pixel point is an edge point based on the gray value of the pixel point and the gray values of pixel points around the pixel point in the edge point extraction device, which comprises: calculates the mean value of the gray values of the pixel points around the pixel point, determines the difference between the mean value and the gray value of the pixel point, and determines that the pixel point is an edge point when the absolute value of the difference exceeds a limit, and determines that the pixel point is a background point when the absolute value of the difference does not exceed a limit; the content analysis device is further used to determine the number of edge points in the combined image, and determines the number of pixel points in the combined image; when the ratio of the number of edge points in the combined image to the number of pixel points in the combined image is lower than a limit, a first operation signal is emitted, and when the ratio of the number of edge points in the combined image to the number of pixel points in the combined image exceeds a limit, a second operation signal is emitted;
a content processing device, which is connected with the content analysis device, and is used to perform feature enhancement processing on the combined image when the first operation signal is received, to obtain a corresponding content processing image, wherein the content processing device performs feature enhancement processing on the combined image with an intensity proportional to the number of edge points in the combined image;
a clothing identification device, which is connected with the content processing device, and is used to receive the content processing image, matching the clothing of the character object in the content processing image based on the clothing of various preset suspicious characters, outputting a key monitoring signal if the matching is successful, and outputting a non-key monitoring signal if the matching fails; and
a ZIGBEE communication device, which is connected with the clothing identification device, and is used to pack the key monitoring signal and the serial number of the heating mechanism together and send to a nearby safety monitoring control center when the key monitoring signal is received.

The multi-functional convection heater further comprising:
a light source device, which is disposed directly above the CMOS sensing device, and is used to send a beam of parallel monochromatic light to the surface of the CMOS sensing device, wherein the light source device emits a parallel monochromatic light with constant light emitting power.

The multi-functional convection heater further comprising:
a light source control device, which is disposed directly above the CMOS sensing device and connected with the light source device, and is used to control the turning on and off of the parallel light emitter.

The multi-functional convection heater further comprising:
a signal measuring device, which is disposed on the surface of the CMOS sensing device, and is used to measure the voltage obtained by converting the parallel monochromatic light into an electrical signal which is used as an actual voltage, divides the actual voltage by a preset reference voltage to obtain a relative attenuation rate, sends a first prompt information when the relative attenuation rate exceeds a limit, and sends a second prompt information when the relative attenuation rate does not exceed a limit, wherein the preset reference voltage is a voltage obtained by converting the parallel monochromatic light into an electric signal when there is no gray scale on the CMOS sensing device.

The multi-functional convection heater further comprising:
a signal analysis device, which is connected with the signal measuring device and the CMOS sensing device, and is used to enter a working mode from a power saving mode when the first prompt information is received, and performs the following operations on the surrounding environment image in the working mode: taking the pixel point of a brightness value in a preset dust brightness value range as a pixel point to be processed, and fits each to-be-processed pixel point in the surrounding environment image into a plurality of regions to be processed; wherein the signal analysis device is also used to receive the plurality of regions to be processed, taking the regions to be processed which have an area matching with the preset dust area as a dust region, and sends a third prompt information when the number of dust regions in the surrounding environment image exceeds a limit.

The multi-functional convection heater further comprising: an intelligent processing device, which is connected with the signal analysis device, and is used to receive the number of dust regions in the surrounding environment image from the signal analysis device when the third prompt information is received, and adopts an ultrasonic dust removal mode which has an intensity directly proportional to the number based on the number of dust regions in the surrounding environment image.

And in the multi-functional convection electric heater: the intelligent processing device is further used to connect with the signal measuring device, and is used to stop the ultrasonic dust removal mode when the second prompt information is received.

In addition, the full name of CMOS is Complementary Metal-Oxide-Semiconductor. It is an important chip in the computer system, which saves the most basic information for system guidance. The manufacturing technology of CMOS is no different from that of general computer chips, wherein the semiconductor is made of silicon and germanium to coexist on the CMOS with N (−charged) and P (+charged). The current generated by these two complementary effects can be recorded and interpreted as an image by the processing chip. Later, it was discovered that CMOS can also be used as an image sensor in digital photography after processing.

For portable applications independent of the power grid, CMOS technology which is well-known for its low power consumption, has a distinct advantage: CMOS image sensors are designed for 5V and 3.3V supply voltages. A CCD chip requires a power supply voltage of about 12V. Therefore, a voltage converter has to be used, resulting in increased power consumption. In terms of total power consumption, the integration of control and system functions into CMOS sensors will bring another benefit: it removes all external connections to other semiconductor components. Its high-power drivers are now deprecated, because the energy consumed for communication inside the chip is much lower than the external implementation through the PCB or substrate.

With the multi-functional convection heater of the present invention, in view of the technical problem of the single structure of heaters in the prior art, different content processing strategies are determined through the analysis result of the gray value of images, thereby improved the feature enhancement effect of images. The scope of image recognition is further narrowed through homomorphic filter processing, histogram equalization processing and threshold adjustment of each sub-image of image segmentation, and the amount of data for subsequent image processing is further reduced. The ultrasonic dust removal method with an intensity proportional to the number of dust regions in the image is adopted to improve the intelligent level of dust removal. The key is the synergistic application of multiple dust detection methods which ensures the accuracy of dust detection. Based on the above data processing, it is possible to judge the clothing of nearby human subjects to determine whether to activate the key monitoring mode, improving the security and prevention capabilities of nearby areas, thereby solving the above technical problems.

It can be understood that although the present invention has been disclosed as the preferred embodiments above, but the above embodiments are not intended to limit the present invention. For anyone skilled in the art, without departing from the scope of the technical solutions of the present invention, the technical contents disclosed above can be used to make many possible changes and modifications to the technical solutions of the present invention, or to be modified to embodiments of equivalent changes having the same effective. Therefore, any simple amendments, equivalent changes, and modifications made to the above embodiments based on the technical essence of the present invention without departing from the technical solution of the present invention still fall within the protection scope of the technical solution of the present invention.

1-9. (canceled)

10. A multi-functional convection electric heater, comprising:
a heating structure, which comprises a ceramic tubular device and a convection device, wherein the ceramic tubular device is used to supply a heating source, and the convection device is connected with the ceramic tubular device, and is used to receive the heat supplied from the ceramic tubular device, and performs subsequent heating in a convection manner; and
a CMOS sensing device, which is used to capture a surrounding environment to obtain and output a corresponding surrounding environment image.
a homomorphic filtering device, which is connected with the CMOS sensing device, and is used to receive the surrounding environment image, performs homomorphic filtering on the surrounding environment image to obtain a corresponding homomorphic filtering image, wherein as the noise amplitude of the surrounding environment image gets larger, the intensity of performing the homomorphic filtering will be increased; and
an equalization processing device, which is connected with the homomorphic filtering device, and is used to receive the homomorphic filtering image, and performs histogram equalization processing on the homomorphic filtering image to obtain a corresponding histogram equalization image;
a first threshold extraction device, which is connected with the equalization processing device, and is used to receive the histogram equalization image, and determines an overall segmentation threshold corresponding to the histogram equalization image based on a distribution condition of pixel values of each pixel point in the histogram equalization image;
a first parameter analysis device, which is used to receive the histogram equalization image, and performs contrast analysis on the histogram equalization image to obtain and output a corresponding contrast;
a first segmentation processing device, which is connected with the first parameter analysis device, and is used to receive the contrast, and performs image segmentation processing on the histogram equalization image based on the contrast to obtain a plurality of sub-images, wherein the higher the contrast is, the more the number of sub-images will be obtained;
a second threshold extraction device, which is connected with the first segmentation processing device, and is used to receive the plurality of sub-images, determines a region segmentation threshold corresponding to the sub-image based on a distribution condition of pixel values of each pixel point in each sub-image, and to output each region segmentation threshold corresponding to each sub-image;
a first numerical adjustment device, which is respectively connected with the second threshold extraction device and the first threshold extraction device, and is used to receive the overall segmentation threshold and each region segmentation threshold, performs numerical adjustment on each region segmentation threshold based on the overall segmentation threshold to obtain an adjusted region segmentation threshold as a region adjustment threshold output; and performs numerical adjustment on each region segmentation threshold based on the overall segmentation threshold in the first numerical adjustment device, which comprises: performs numerical adjustment on the region segmentation threshold based on a difference size of the overall segmentation threshold to each region segmentation threshold; and performs numerical adjustment on the region segmentation threshold based on a difference size of the overall segmentation threshold to each region segmentation threshold in the first numerical adjustment device, which comprises: the adjusted region segmentation threshold is the sum of the region segmentation threshold and a quarter of the difference;
a second segmentation processing device, which is connected with the first numerical adjustment device, and is used to perform segmentation processing on the region adjustment threshold corresponding to each sub-image to obtain a corresponding target sub-image, and to combine all the target sub-images to obtain and output the combined image;
a content analysis device, which is connected with the second segmentation processing device, and is used to receive the combined image, acquires a gray value of each pixel point in the combined image, and performs the following operations for each pixel point: determines whether the pixel point is an edge point based on the gray value of the pixel point and the gray values of pixel points around the pixel point; wherein, to determine whether the pixel point is an edge point based on the gray value of the pixel point and the gray values of pixel points around the pixel point in the edge point extraction device, which comprises: calculates the mean value of the gray values of the pixel points around the pixel point, determines the difference between the mean value and the gray value of the pixel point, and determines that the pixel point is an edge point when the absolute value of the difference exceeds a limit, and determines that the pixel point is a background point when the absolute value of the difference does not exceed a limit; the content analysis device is further used to determine the number of edge points in the combined image, and determines the number of pixel points in the combined image; when the ratio of the number of edge points in the combined image to the number of pixel points in the combined image is lower than a limit, a first operation signal is emitted, and when the ratio of the number of edge points in the combined image to the number of pixel points in the combined image exceeds a limit, a second operation signal is emitted;
a content processing device, which is connected with the content analysis device, and is used to perform feature enhancement processing on the combined image when the first operation signal is received, thereby to obtain a corresponding content processing image, wherein the content processing device performs feature enhancement processing on the combined image with an intensity proportional to the number of edge points in the combined image;
a clothing identification device, which is connected with the content processing device, and is used to receive the content processing image, matching the clothing of the character object in the content processing image based on the clothing of various preset suspicious characters, outputting a key monitoring signal if the matching is successful, and outputting a non-key monitoring signal if the matching fails; and
a ZIGBEE communication device, which is connected with the clothing identification device, and is used to pack the key monitoring signal and the serial number of the heating mechanism together and send to a nearby safety monitoring control center when the key monitoring signal is received.

11. The multi-functional convection electric heater according to claim 10, characterized by the heater further comprising:
a light source device, which is disposed directly above the CMOS sensing device, and is used to send a beam of parallel monochromatic light to the surface of the CMOS sensing device, wherein the light source device emits a parallel monochromatic light with constant light emitting power.

12. The multi-functional convection electric heater according to claim 11, characterized by the heater further comprising:
a light source control device, which is disposed directly above the CMOS sensing device and connected with the light source device, and is used to control the turning on and off of the parallel light emitter.

13. The multi-functional convection electric heater according to claim 12, characterized by the heater further comprising:
a signal measuring device, which is disposed on the surface of the CMOS sensing device, and is used to measure the voltage obtained by converting the parallel monochromatic light into an electrical signal which is used as an actual voltage, divides the actual voltage by a preset reference voltage to obtain a relative attenuation rate, sends a first prompt information when the relative attenuation rate exceeds a limit, and sends a second prompt information when the relative attenuation rate does not exceed a limit, wherein the preset reference voltage is a voltage obtained by converting the parallel monochromatic light into an electric signal when there is no gray scale on the CMOS sensing device.

14. The multi-functional convection electric heater according to claim 13, characterized by the heater further comprising:
a signal analysis device, which is connected with the signal measuring device and the CMOS sensing device, and is used to enter a working mode from a power saving mode when the first prompt information is received, and performs the following operations on the surrounding environment image in the working mode: taking the pixel point of a brightness value in a preset dust brightness value range as a pixel point to be processed, and fits each to-be-processed pixel point in the surrounding environment image into a plurality of regions to be processed; wherein the signal analysis device is also used to receive the plurality of regions to be processed, taking the regions to be processed which have an area matching with the preset dust area as a dust region, and sends a third prompt information when the number of dust regions in the surrounding environment image exceeds a limit.

15. The multi-functional convection electric heater according to claim 14, characterized by the heater further comprising:
an intelligent processing device, which is connected with the signal analysis device, and is used to receive the number of dust regions in the surrounding environment image from the signal analysis device when the third prompt information is received, and adopts an ultrasonic dust removal mode which has an intensity directly proportional to the number based on the number of dust regions in the surrounding environment image.

16. The multi-functional convection electric heater according to claim 15, characterized by:
the intelligent processing device is further used to connect with the signal measuring device, and is used to stop the ultrasonic dust removal mode when the second prompt information is received.
